(19) United States
(12) Patent Application Publication
(10) Pub. No.: US 2025/0241472 A1
(43) Pub. Date: Jul. 31, 2025

(54) COFFEE PRESS TRAVEL ASSEMBLY

(71) Applicant: AeroPress, Inc., Palo Alto, CA (US)

(72) Inventors: Matthew Brown, Raleigh, NC (US); Dale Woiken, Upland, CA (US); Edmund Lee, Encino, CA (US)

(73) Assignee: AeroPress, Inc., Palo Alto, CA (US)

(21) Appl. No.: 19/038,154

(22) Filed: Jan. 27, 2025

Related U.S. Application Data
(60) Provisional application No. 63/644,271, filed on May 8, 2024.
(60) Provisional application No. 63/625,479, filed on Jan. 26, 2024.

(51) Int. Cl. A47J 31/02; A47G 19/22; A47J 31/06; A47J 31/08; A47J 31/44

(52) U.S. Cl. CPC A47J 31/02; A47G 19/2272; A47J 31/0657; A47J 31/085; A47J 31/4407

(57) ABSTRACT

A portable assembly for making beverages comprising: a beverage filter press, a tumbler configured to receive the beverage filter press securely therein, and a lid configured to securely attach to the tumbler for travel use. The beverage filter press can include features, such as tabs, which engage an underside of the lid to secure the assembly together by a friction-fit. The portable assembly can further include a collapsible stirrer and a magnetic lid. The lid can include a movable tab including a first magnet, and a body including a second magnet, a third magnet, and an opening. The first magnet is configured to couple to the second magnet to maintain the movable tab in a closed position, and the first magnet configured to couple to the third magnet to maintain the movable tab in an open position.

### CROSS-REFERENCE TO RELATED APPLICATIONS

The present application is a Non-Provisional of and claims the benefit of priority to U.S. Provisional Application No. 63/625,479 filed Jan. 26, 2024 and U.S. Provisional Application No. 63/644,271 filed May 8, 2024, the full disclosures of which are incorporated herein by reference in their entirety for all purposes.

### FIELD OF THE INVENTION

The present invention relates generally to beverage makers and more specifically to beverage presses for making coffee or tea, and associated travel assembly and travel tumblers.

### BRIEF SUMMARY

According to an aspect of the present invention, a portable assembly, which facilitates the use of a beverage filter press during travel is described herein. In some embodiments, the portable assembly includes such a beverage filter press, typically for filtering coffee beverages. The beverage filter press includes a hollow cylinder having top and bottom openings, a removable filter cap couplable to the hollow cylinder so as to enclose the bottom opening of the hollow cylinder, and a removable piston configured to be inserted into the top opening of the hollow cylinder creating an airtight seal. The portable assembly can further include a tumbler configured to receive the filter press securely therein and a lid configured to securely attach to the tumbler for travel use. The lid is configured to securely attached to the bottom side of the hollow cylinder to secure the beverage filter press within the portable assembly for travel. The invention pertains to improvement of such portable assemblies and components therein that facilitate use of such beverage presses while traveling.

In some embodiments, the lid is sized to accommodate a filter cap attached to the second opening of the hollow cylinder when secured to the hollow cylinder within the portable assembly.

In some embodiments, a support extends laterally outward from an exterior of the hollow cylinder at the bottom side, wherein the hollow cylinder comprises tabs extending from the support and configured to engage an inner surface of the lid to securely attach to the lid within the portable assembly.

In some embodiments, the tabs comprise at least a pair of tabs on opposite lateral sides of the hollow cylinder that engage the inside surface of the lid in a friction fit.

In some embodiments, the tabs comprise three or more tabs distributed about the second opening.

In some embodiments, the lid and the tumbler comprise corresponding threads or ramped surfaces to facilitate secure attachment of the lid to the tumbler for travel use.

In some embodiments, the tumbler includes an openable compartment at a bottom thereof for storing a stack of paper filters for use in the beverage filter press.

In some embodiments, the tumbler has a diameter at or near a bottom thereof sized at about 3.5 inches or less to fit within a standard cup-size holder.

In some embodiments, the portable assembly is provided to a user as a kit including a filter cap and a stack of paper filters stored within a bottom compartment of the tumbler.

In some embodiments, the hollow cylinder includes a silicone ring to secure the beverage filter press in place when disposed within the tumbler.

In some embodiments, at least the beverage filter press, the tumbler, and the lid are held together by a press-fit or friction-fit.

In some embodiments, the lid can include on or more magnets in the tab or lid body that helps maintain the tab in a set position, (e.g., the closed and/or the open position). In some embodiments, the tab includes a magnet or ferromagnetic metal that is positioned to correspond to another magnet or ferromagnetic metal in the lid body so as to hold the tab in position when the magnets are aligned. The position can be one or both of an open position and a closed position. In some embodiments, the lid is without any snap-fit or friction-fit coupling to secure the position, and the tab design relies only on the one or more magnets to secure the position of the tab in the closed and/or open position. In some embodiments, the tab includes a magnet, and the lid body includes a first magnet at a first position that magnetically couples to the tab magnet when the tab is in the closed position and a second magnet at a second position that magnetically couples to the tab magnet when the tab is in the open position. In some embodiments, the tab sits in a groove and slides back and forth between the open and closed position. In some embodiments, the tab is not attached to the lid body and the magnets are the only thing that hold the slider down.

In some embodiments, the lid of the portable assembly further comprises a movable tab with at least a first magnet. The movable tab is configured to transition between at least a closed position and an open position, where the closed position correspond to an opening being covered by the movable tab and the open position corresponds to at least a portion of the opening being uncovered by the movable tab. The lid further includes a body with at least a second magnet, a third magnet, and the opening. The body can be configured to securely attach to the tumbler of the portable assembly for portability or travel use. Furthermore, the first magnet of the movable tab is configured to couple to the second magnet of the body such that the movable tab is maintained in the closed position and the first magnet of the movable tab is configured to couple to the third magnet of the body such that the movable tab is maintained in the open position.

In some embodiments, the lid is configured such that when a force is applied to the movable tab in a first direction, the first magnet decouples from the second magnet and couples to the third magnet, transitioning the movable tab from the closed position to the open position. In some embodiments, the lid is configured such that when a force is applied to the movable tab in a second direction, the first magnet decouples from the third magnet and couples to the second magnet, transitioning the movable tab from the open position to the closed position, wherein the first direction and the second direction are opposite.

In some embodiments, the portable assembly further comprises a stirrer that is collapsible between an expanded configuration for stirring grounds within the hollow cylinder of the beverage filter press and a folded configuration that fits entirely within the hollow cylinder for storage. The stirrer can include multiple members or portions that fold relative each other to collapse the stirrer to fit within the travel mug for storage when not in use.

In some embodiments, the stirrer includes a first portion comprising at least a first pivot and a stop; a second portion comprising at least a first hole, a second hole, and a groove; and a third portion comprising at least a second pivot. The first, second, and third portions are coupled together to enable the stirrer to be transitioned between a folded configuration and an expanded configuration. Specifically, the first hole of the second portion can be rotatably coupled to the first pivot of the first portion to permit rotation of the first portion about the first pivot. Moreover, the groove can be coupled to the stop of the first portion to limit the rotation of the first portion about the first pivot. Finally, the second pivot of the third portion can be rotatably coupled to the second hole of the second portion to permit rotation of the third portion about the second pivot. Thus, after a user is finished utilizing the stirrer in the expanded configuration, the stirrer may be transitioned to the folded configuration for easy storage and transport.

In some embodiments, the stirrer transitions to the expanded configuration by rotating the first portion about the first pivot in a first direction and rotating the third portion about the second pivot in the first direction. In some embodiments, the stirrer transitions to the folded configuration by rotating the first portion about the first pivot in a second direction and rotating the third portion about the second pivot in the second direction, wherein the first direction and the second direction are opposite.

The stirrer and the lid may be included in the portable assembly, which further includes a specialized beverage press that fits within a tumbler along with the stirrer. Thus the tumbler serves two functions, storing the beverage press and stirrer for portability, and providing a travel drinking container for drinking beverages made with the beverage press. Such beverage presses can be sized and dimensioned to fit within a travel tumbler sized for a standard cup holder size.

A further understanding of the nature and advantages of the present invention may be realized by reference to the remaining portions of the specification and the drawings.

### BRIEF DESCRIPTION OF THE DRAWINGS

FIG. 1A-1B illustrate exemplary travel assemblies that include a beverage press assembly secured within a travel tumbler with lid, in accordance with various embodiments;

FIG. 2A illustrates an exploded view of the exemplary travel assembly shown in FIG. 1A, in accordance with various embodiments;

FIG. 2B illustrate an exploded view of the exemplary travel assembly shown in FIG. 1B, in accordance with various embodiments;

FIG. 2C illustrates an exploded view of an exemplary beverage press included in the exemplary travel assembly shown in FIG. 2B, in accordance with various embodiments;

FIG. 3 illustrates another exemplary travel assembly that includes the beverage press assembly, in accordance with various embodiments;

FIG. 4 illustrates an exemplary beverage press resting on a cup with a stirrer deployed during the initial mixing stage, in accordance with various embodiments;

FIG. 5 illustrates the exemplary beverage press with the piston deployed during the pressing stage, in accordance with various embodiments;

FIG. 6 illustrates another exemplary beverage press with the support extending radially outward from the perforated cap, in accordance with various embodiments;

FIGS. 7A-7C illustrate an exemplary lid that includes a magnetic tab, in accordance with various embodiments;

FIG. 8 illustrates a cross-sectional view of the exemplary lid along plane A-A as shown in FIG. 7B, in accordance with various embodiments;

FIGS. 9A-9C illustrate another exemplary lid that includes a magnetic tab, in accordance with various embodiments;

FIG. 10 illustrates a cross-sectional view of the exemplary lid along plane B-B as shown in FIG. 9B, in accordance with various embodiments;

FIGS. 11A-11B illustrate an exemplary travel stirrer in an expanded configuration, in accordance with various embodiments; and

FIGS. 12A-12C illustrate the exemplary travel stirrer in a folded configuration, in accordance with various embodiments.

### DETAILED DESCRIPTION

In one aspect, the invention pertains to a beverage press for pressing beverage servings, in accordance with some embodiments, in particular a beverage press utilized in a travel assembly.

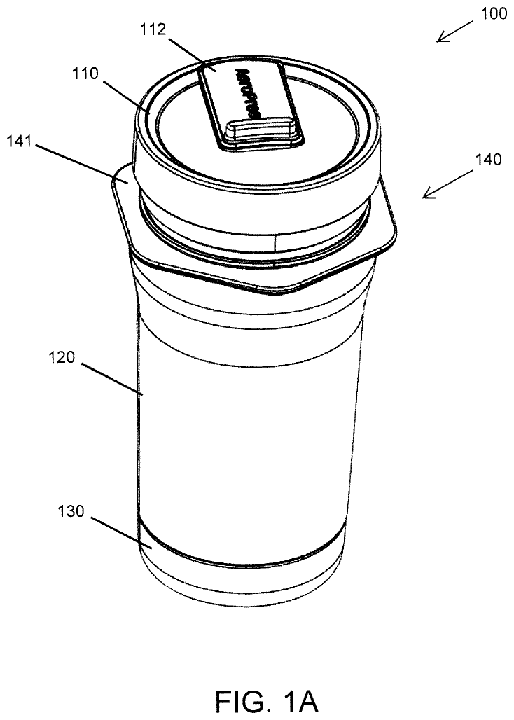

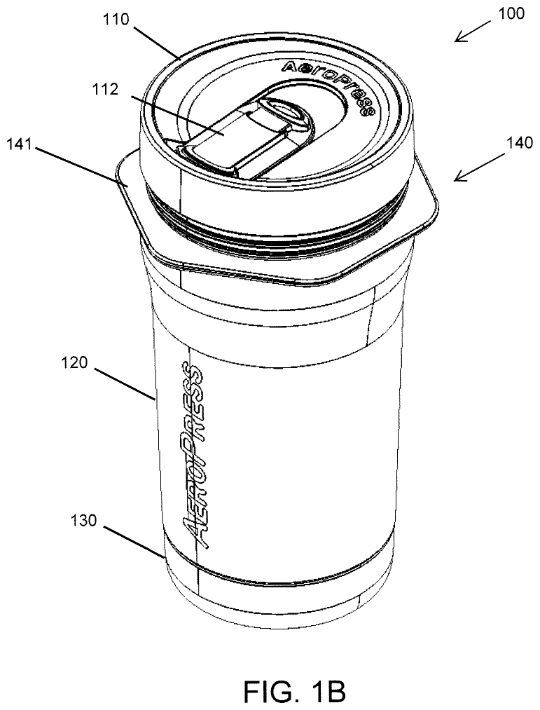

FIGS. 1-3 illustrate exemplary travel assemblies 100 that include a beverage press 140 assembly secured within a travel tumbler 120 with lid 110, in accordance with some embodiments. FIG. 1A illustrates an exemplary travel assembly 100 that includes a beverage press assembly 140 secured within a travel tumbler 120 with lid 110, in accordance with various embodiments. and FIG. 1B illustrates an alternative embodiment of the travel assembly 100 in FIG. 1A with same or similar components, except an alternate design of lid 110. In some embodiments, the assembled travel kit (e.g., travel assembly 100) includes a tumbler 120 and a lid 110. In some embodiments, the tumbler 120 further includes an openable compartment 130 at the bottom for storing components, such as filter papers.

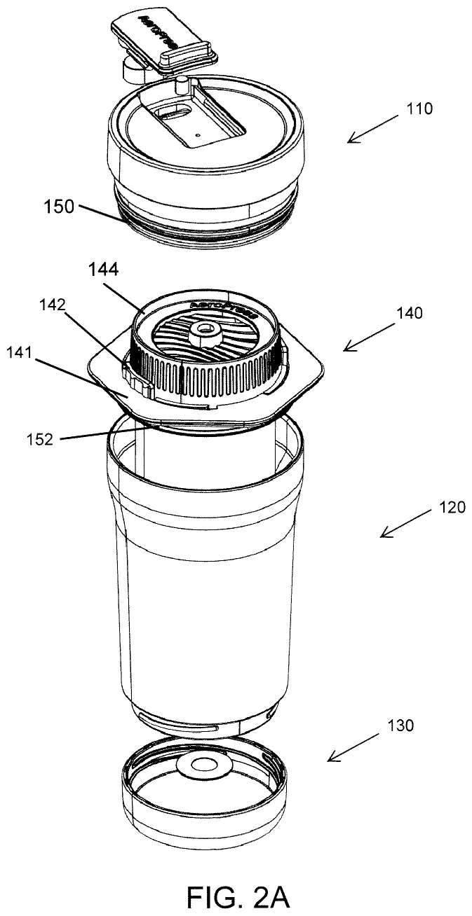

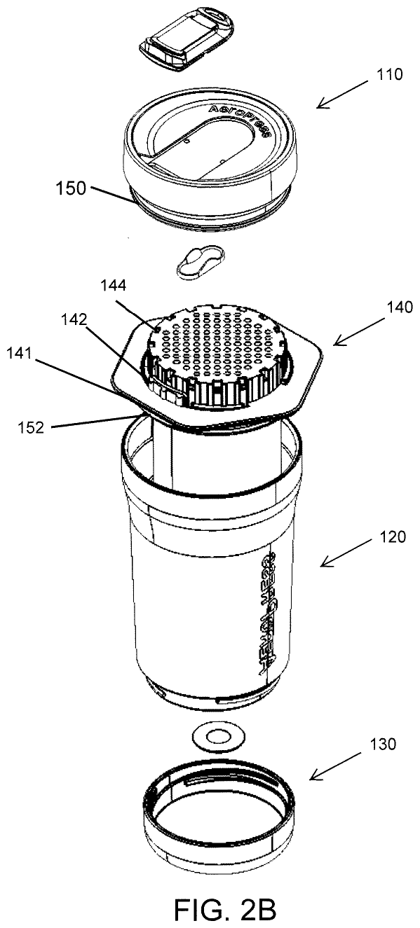

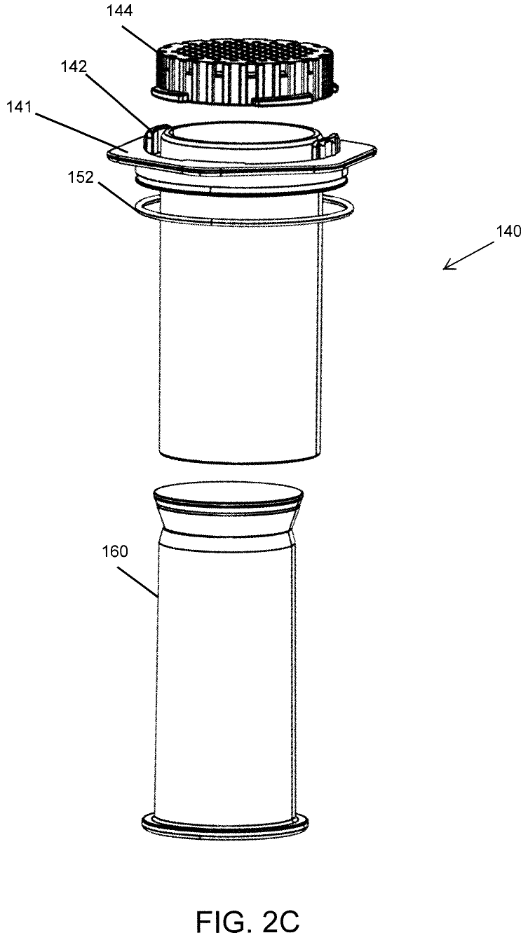

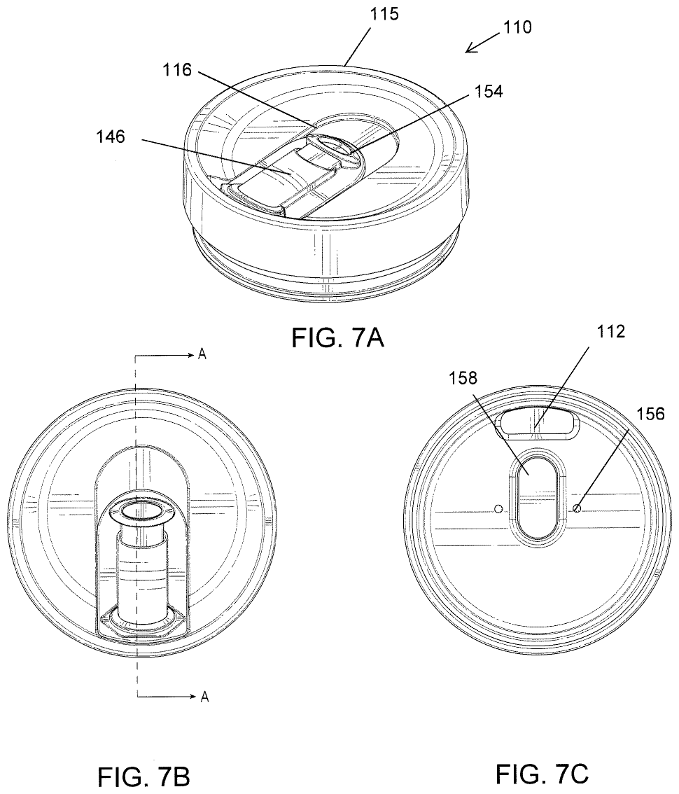

In this embodiment, the lid 110 includes a coverable opening 112 for drinking that a user can selectively open and close to facilitate use as a drinking container while traveling. As will be discussed in further detail with respect to FIGS. 7-8 and 11-12 below, the lid 110 may include one or more magnets 148 to facilitate the selective opening and closing of the coverable opening 112 by movable tab. In some embodiments, the lid 110 is configured to securely attach to the tumbler 120 for travel use. For example, the lid 110 may be configured to use a press-fit or friction-fit to securely attach to the tumbler 120. In another example, the lid 110 and/or tumbler 120 may include corresponding features, such as recesses, ridges, or contours that engage or interlock, to secure the lid 110 to the tumbler 120. For example, the lid 110 and the tumbler 120 comprise corresponding threads 150 (as shown in FIG. 2A) to facilitate secure attachment of the lid 110 to the tumbler 120 for travel use. Furthermore, the tumbler 120 is configured to receive the beverage press 140 securely therein, such that when assembled, as shown, the tumbler 120 stores the beverage press 140.

When assembled, the outer cylinder of the beverage press 140 is secured to each of the lid 110 and the tumbler 120. In some embodiments, the outer cylinder is secured to each by a press-fit or friction-fit, although any suitable attachment means, or combination of means could be used. For example, the outer cylinder of the beverage press 140 may be secured to the lid 110 and/or tumbler 120 via corresponding features, such as recesses, ridges, or counters. In some embodiments, the outer cylinder and/or the proximal end of the piston 160 can include a silicone ring 152 (as shown in FIGS. 2A-2C) that engages the inside of the tumbler 120 to help keep the beverage press 140 in place by a press-fit or friction-fit. For example, a silicone ring 152 may be located near the laterally extending support 141 of the beverage press 140, in this embodiment, the silicone ring 152 fits within a corresponding grove of the lateral support 141. In some embodiments, at least a portion of the beverage press 140 is visible when the travel kit (e.g., travel assembly 100) is assembled. For example, in FIG. 1, only the laterally extending support 141 of the outer cylinder of the beverage press 140 is visible. Although the support 141 in this embodiment is hexagonal, it is appreciated that the support 141 can be any shape (e.g., polygonal, circular, etc.).

In some embodiments, including this embodiment shown in FIGS. 1A-1B, a bottom compartment 130 of the tumbler 120 is removable to facilitate storage of a stack of filters (e.g., paper filters) therein. For example, the tumbler 120 may include a bottom compartment 130 that is openable. Thus the base of the tumbler 120 may be removed allowing for the storage of materials, such as a stack of paper filters for use in the beverage press 140.

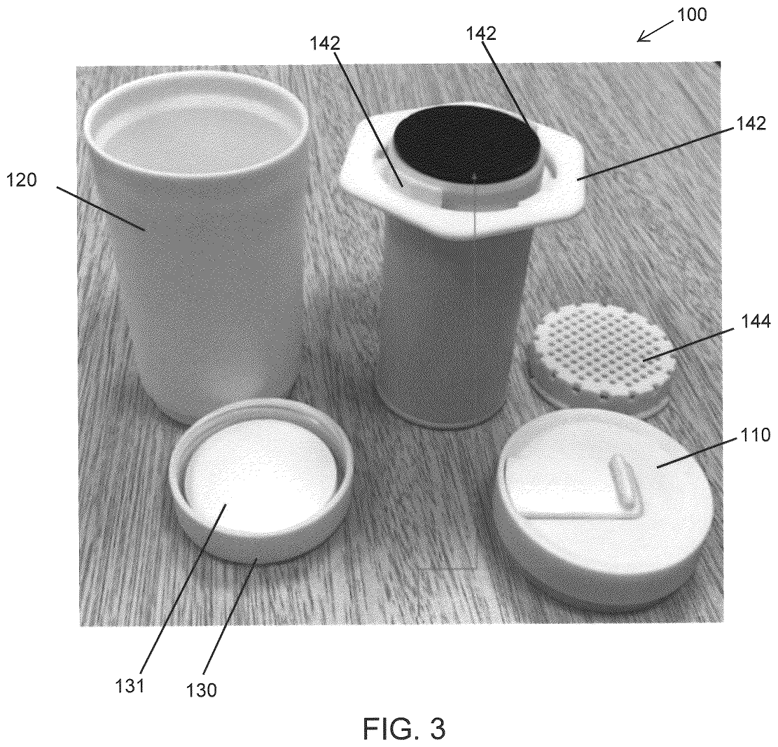

FIG. 2A illustrates an exploded view of the exemplary travel assembly 100 shown in FIG. 1A, FIG. 2B illustrates an exploded view of the alternative embodiment of the travel assembly 100 in FIG. 1B, FIG. 2C illustrates an exploded view of an exemplary beverage press 140 included in the exemplary travel assembly 100 shown in FIG. 2B, and FIG. 3 illustrates another exemplary travel assembly 100 that includes the beverage press assembly 140, in accordance with various embodiments. FIG. 2A and FIG. 2B, in particular, provides a clear illustration of the removal of the bottom compartment 130 from the tumbler 120 as well as the beverage press 140 that fits within the tumbler 120. The bottom compartment 130 can be secured to the tumbler 120 by corresponding threads 150 such that the component screws onto the tumbler 120. Alternatively, the bottom compartment 130 can be attached by any suitable means. For example, the bottom compartment 130 may be secured to the tumbler 120 using a friction-fit.

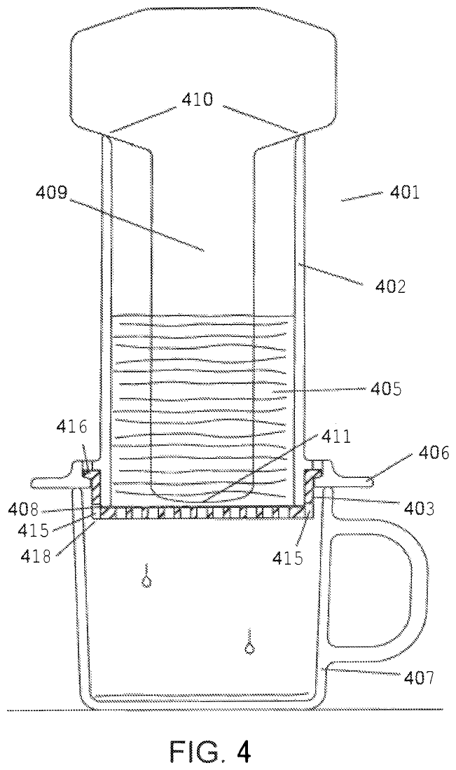

In some embodiments, the beverage press 140 includes at least an outer cylinder (e.g., hollow cylinder), a filter cap 144 disposed on the bottom opening of the cylinder, and a piston 160 disposed within the cylinder (not visible in this view). See FIGS. 4-6 for additional details regarding the placement and operation of the piston 160 within the cylinder. Specifically, the beverage press 140 includes an outer cylinder having a first opening at a top side and a second opening at a bottom side. The outer cylinder is sized to fit within the tumbler 120, such that the beverage press 140 can be received by the tumbler 120. The beverage press 140 further includes a filter cap 144 attached over the bottom opening of the cylinder and configured to be removable to facilitate disposal of spent grounds and filter papers. In particular, the filter cap 144 is couplable to the outer cylinder so as to enclose the second opening at the bottom side of the outer cylinder. The beverage press 140 further includes a removable piston 160. The piston 160 is configured to be inserted into the outer cylinder and creates an airtight seal when coupled with the outer cylinder such that when pressed, the piston 160 forces beverage (e.g., coffee formed by steeping water with coffee grounds) through the filter paper to dispense the beverage.

The beverage press 140 has a laterally extending support 141 extending outward from an exterior of the outer cylinder and from or near the bottom opening of the outer cylinder. The outer cylinder further includes one or more tabs 142 extending downwards from the support 141. As shown in FIGS. 2A-3, the support 141 further includes tabs 142 extending downward from the support 141 (upwards in this view in which the cylinder is inverted) so as to engage an inside surface of the lid 110 to secure the components together. For example, the tabs 142 may be implemented to engage the inside surface of the lid 110 (e.g., inner facing surface of the lid sidewalls) securely attaching the lid 110 within the beverage press assembly 140. The filter cap is attached to the beverage press cylinder by corresponding threads or ramped surfaces, or any suitable means and the piston 160 is attached to the beverage press cylinder by a friction fit. In some embodiments, the lid 110 and outer cylinder can attach by a press-fit or friction-fit between the one or more tabs 142 and inside surface of the lid. In other embodiments, the lid 110 can further include corresponding features, such as recesses, ridges, or contours that engage or interlock, to attach the components together. In this embodiment, the outer cylinder includes a pair of tabs 142 disposed on opposite lateral sides of the outer cylinder. For example, a pair of tabs 142 disposed on opposite lateral sides of the outer cylinder may be used to engage the inside surface of the lid 110 using a friction-fit or other suitable means. In another embodiment, the outer cylinder includes three or more tabs 142 distributed about the outer cylinder. For example, three tabs 142 may be distributed about the second opening on the bottom side of the outer cylinder.

In this embodiment, the top of the piston 160 is sized suitably small to allow the piston 160 disposed within the outer cylinder to be pressed down into the tumbler 120. For example, as shown in FIGS. 2A-2C, the piston 160 may be sized such that it can be received by the tumbler 120. In some embodiments, as shown in FIG. 2C, the top of the piston 160 extends laterally outward only a short distance (e.g., 1-10 mm) so that the piston 160 fits within the tumbler 120. The lid 110 is sized so that the lid 110 attaches to the outer cylinder while a filter cap 144 is attached to the bottom of the outer cylinder. Thus, when the lid 110 is secured to the bottom side of the outer cylinder of the beverage press 140, the lid 110 is sized to accommodate the filter cap 144 when it is attached to the second opening of the outer cylinder. Accordingly, the assembled travel kit (e.g., travel assembly 100) securely holds all the components of the travel tumbler 120 and beverage press 140 needed to make and drink a coffee beverage while traveling, as can be seen in FIG. 3, including filters 131 (e.g., paper filters) conveniently stored within the removable bottom compartment 130.

In some embodiments, additional means to secure the beverage press 140 in place when pressed into the tumbler 120 are used. Specifically, as shown, the outer cylinder can include a silicone ring 152 disposed on the outside to help keep the beverage press 140 in place when pressed into the tumbler 120. Additionally or alternatively, at least a portion of the beverage press 140 and the tumbler 120 may include corresponding features, such as recesses, ridges, or contours that engage or interlock to secure the beverage press 140 in place when pressed into the tumbler 120.

Advantageously, the beverage press 140 and tumbler 120 can be sized to fit a standard cup-size holder in transit vehicles (e.g., autos, trains, etc.). In some embodiments, the diameter of at least the lower portion (at or near the bottom) of the tumbler 120 is about 3.5″ or less, which fits most standard sizes of cup-holders. In some embodiments, the outer cylinder, tumbler 120 and lid 110 are each made of hard plastic, which facilitates secure attachment by a press-fit or friction-fit and which is easy to clean and withstands damage during travel. It is appreciated that various other materials and sizing of components could be used as well.

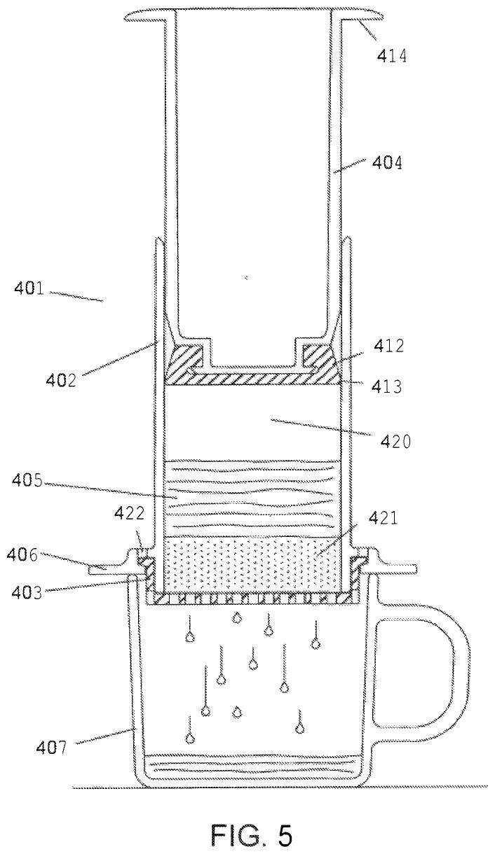

FIG. 4 illustrates an exemplary beverage press 401 resting on a cup with a stirrer 409 deployed during the initial mixing stage, in accordance with various embodiments. FIG. 5 illustrates the exemplary beverage press 401 with the piston 404 deployed during the pressing stage, in accordance with various embodiments. It is appreciated that these aspects are exemplary to illustrate how the respective components function during use and that these aspects can pertain to any of the presses described herein. It is understood that the beverage press 401 can be of various differing sizes and capacities, including the oversized beverage presses 401 described in U.S. Patent Pub. No. 2024/0349932 filed Apr. 22, 2023, incorporated herein by reference. Exemplary operation of the beverage press 401 can be further understood by referring to FIGS. 4-6 detailed further below.

The beverage press 401 includes a hollow cylinder 402, a removable filter cap 403, and a piston 404 with a flexible seal 412. The hollow cylinder 402 may have a top and bottom opening where the bottom opening is enclosed with the removable filter cap 403. For example, a removable filter cap 403 may be coupled with the bottom opening of the hollow cylinder 402 enclosing one end of the hollow cylinder 402. In an embodiment, the filter cap 403 can support a removable filter 408. For example, a paper filter 408 may be positioned within a cavity of the filter cap 403. The filter 408 may be made out of any suitable material for filtering of the beverage. For example, the filter 408 may be made out of metal, paper, etc. The filter 408 may be captured between the cap 403 and the hollow cylinder 402 to strain particles from the liquid 405. For example, a paper filter 408 may be located on the cap 403 facilitating the filtering of liquid 405 being pressed through the hollow cylinder 402. In an alternative embodiment, the filter 408 may be integrated into the cap 403 structure. For example, the cap 403 may be designed to include a filtering structure suitable for filtering a beverage. While a perforated filter cap 403 with multiple holes is shown, it is appreciated any filter cap 403 could be used (e.g., pressure-activated valve cap).

The beverage press 401 may further include the piston 404 with a flexible seal 412. The flexible seal 412 may be located at a first end of the piston 404. As a result, when the piston 404 with the flexible seal 412 is inserted within the hollow cylinder 402, the piston 404 with the seal 412 may be utilized to press liquid 405 through the hollow cylinder 402. For example, the seal 412 may be located at the bottom of the piston 404, which can be used as a plunger to press a beverage through the body of the hollow cylinder 402. In some embodiments, the flexible seal 412 may be an airtight seal 412. The removable piston 404 may be inserted into the top opening and pressed downward to force liquid 405 in the hollow cylinder 402 through the filter cap 403. In some embodiments, the piston 404 may further include a stop 414 and a support 406. The stop 414 may be located at the top of the piston 404 (e.g., a second end of the piston 404). For example, the stop 414 may be located at the opposite end of the piston 404 from the seal 412. The support 406 may extend laterally from near the bottom opening of the hollow cylinder 402 and may be used to rest the beverage press 401 on a vessel 407 in which the beverage is dispensed. Thus, the support 406 can be utilized to hold the beverage press 401 on the mouth of an open vessel 407 providing more stability during pressing. In some embodiments, the support 406 has a regular polygonal shape. For example, as depicted in FIGS. 1-3, the support 406 has a hexagonal shape. However, it is appreciated that the support 406 may be any polygonal shape, or any suitable non-polygonal shape.

FIG. 4 further depicts a stirrer 409 or stirring paddle having upper stop 410 and a length, measured from its lower extremity (e.g., tip 411) to stop 410, which is slightly less than the length of cylinder 402. The stop 410 prevents the tip 411 of the paddle (e.g., stirrer 409) from touching the cap 403 or the filter 408 during stirring.

In operation, the press 401 is placed on an open vessel 407. Ground coffee or tea is put into the cylinder 402. Hot water is added, and the mixture is stirred with paddle (e.g., stirrer 409). The paddle (e.g., stirrer 409) is then removed and piston 404 is inserted into the top opening and pressed downward to force the liquid 405 through the filter 408 and perforated cap 403 and into the vessel 407. The piston 404 pressurizes the air 20, above the liquid 405 and it is this pressurized air 420 which forces the liquid 405 through the cap 403. When the liquid 405 is expelled, the press 401 is then lifted off the vessel 407 and the cap 403 is removed. Finally piston 404 is pressed further to eject the spent puck 421 of coffee or tea into a waste receptacle.

The piston 404 is capped with a flexible seal 412 to engage the inside of the cylinder 402. The seal 412 preferably has its maximum diameter 413 at its lowest point in order to wipe clean the inside of the cylinder 402 when the maximum diameter 413 is pushed fully through the cylinder 402 with the cap 403 removed during ejection of the spent puck 421.

The piston 404 has a stop 414 which limits the maximum travel of the piston 404 but permits the maximum diameter 413 of the seal 412 to extend beyond the bottom opening of the cylinder 402 with the cap 403 removed to eject the spent puck 421.

The perforated cap 403 has one or more holes on the bottom. In some embodiments, the cap 403 includes a single central opening with a pressure-activated valve. In the embodiment shown, the cap 403 includes multiple holes to allow flow of beverage therethrough. In the embodiment shown, the cap 403 further includes multiple drain holes 415, adjacent to and radially external to a perimeter line defined by the outer circumference of the bottom of cylinder 402. These drain holes 415 relieve pressure between the outer wall of the cylinder 402 and the inner wall of the cap 403 and prevent leakage out of the top edge of the cap 403.

In FIGS. 4 and 5, perforated cap 403 is attached to cylinder 402 with a twist lock 416. This twist lock 416 can include four ramped grooves in the support/base that receive correspondingly shaped tabs in the filter cap 403. This attachment can be used to attach the filter cap 403 in any of the beverage presses described herein. Alternatively, various other attachment means could be used.

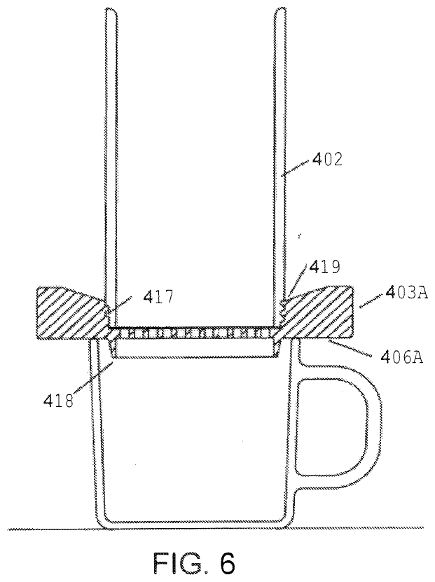

FIG. 6 illustrates another exemplary beverage press 401 with the support 406A extending radially outward from the perforated cap 403A, in accordance with some embodiments. This figure also illustrates an alternative attachment method in which the perforated cap 403A is attached to the cylinder 402 with a screw thread 417. Yet another alternative would be to secure the perforated cap 403A to the cylinder 402 with a latch. The alternative cap 403A and support 406A of FIG. 6 also have an upper cavity 419 to collect liquid 405 which may leak between the cylinder 402 and the cap 403A.

FIGS. 4-6 also illustrate a central bottom step 418 which extends below the rim of the open vessel 407 in order to keep the press 401 from slipping off the vessel 407. In FIGS. 4 and 5, this bottom step 418 is the lower portion of cap 403. In FIG. 6, bottom step 418 is an extension below the lower surface of cap 403A. This central bottom step 418 may or may not contact the inner walls of the vessel 407 depending on the size of the opening of the vessel 407.

Supports 406 and 406A are shaped to permit air to pass readily out of the open vessel 407 when the press 401 is resting on top of the vessel 407 and liquid 405 is entering the vessel 407. The twist lock 416 of FIG. 4 and FIG. 5 has through-holes 422 which achieve this. In the alternative embodiment of FIG. 6, the bottom surface of support 406A is roughened or grooved to achieve this same result.

While the cylinder 402 may be made from a wide range of materials, the preferred materials are transparent so that the user can observe the pressing process. For example, glass and transparent plastics may be suitable for the cylinder 402. The piston 404 can also be made of any suitable transparent, clear, or opaque (e.g., metal) material.

It is appreciated that a wide range of dimensions are feasible for the invention. In some embodiments, a cylinder 402 having an inside diameter of approximately 402.25 inches and a length of approximately 5 inches has been found to perform very well for pressing a quantity of beverage suitable for a single serving of beverage (e.g., 250 ml capacity), for example, to dispense an amount suitable for a standard cup of coffee or tea. In some embodiments, a cylinder 402 having a larger diameter and height is used for dispensing a larger quantity of beverage, such as twice the capacity (e.g., 500 ml or more), as discussed previously.

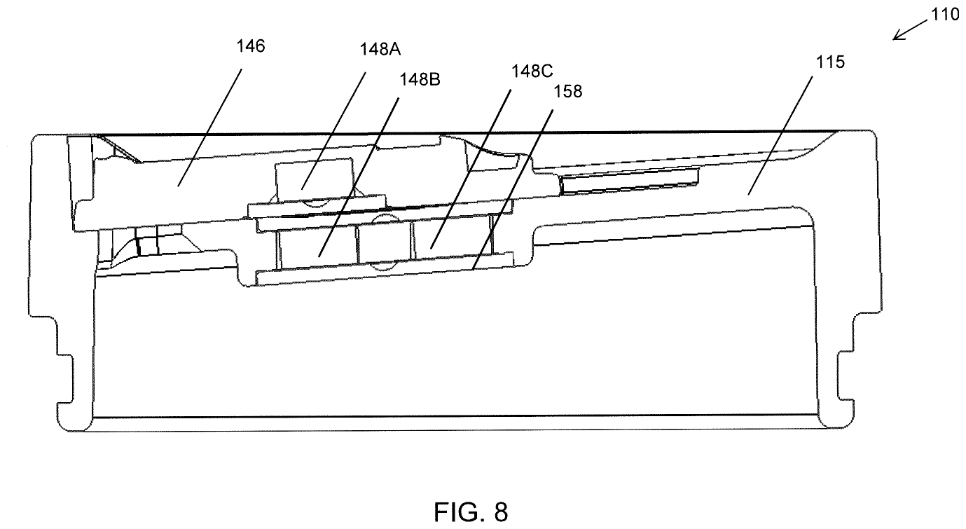

FIGS. 7A-7C illustrate an exemplary lid 110 that includes a magnetic tab 146, in accordance with various embodiments. As discussed with respect to FIG. 1, the lid 110 includes a lid body 115 and a coverable opening 112 that a user can selectively open and close to facilitate use as a drinking container while traveling. In an embodiment, the coverable opening 112 may further comprise a magnetic tab 146, which can be used to maintain an open and/or close configuration of the coverable opening 112. Specifically, as depicted in FIG. 8, the magnetic tab 146 may include one or more magnets 148 designed to couple with one or more magnets 148 in the lid body 115 such that the magnetic tab 146 may be held in at least an open and/or closed configuration. The tab 146 may include a tactile feature 154 to facilitate manual opening and closing of the tab 146 with the user's finger. In this embodiment, the tactile feature 154 is designed as a depiction of the classic AeroPress coffee press. FIG. 7C illustrate a bottom view of the exemplary lid 110 that includes a magnetic tab 146, in accordance with various embodiments. As shown in FIG. 7C, a coverable opening 112 may be located on or near the outer perimeter of the lid body 115. In some embodiments, one or more holes 156 may be located on the lid body 115. The holes 156 may allow ventilation of the travel assembly 100 to prevent the formation of a vacuum as a beverage cools. In some embodiments, the lid body 115 further includes a cover 158. The cover 158 may be located over the one or more magnets 148 included in the lid body 115 to further secure the magnets 148 and/or protect the magnets 148 from a beverage during use of the travel assembly 100.

FIG. 8 illustrates a cross-sectional view of the exemplary lid 110 along plane A-A as shown in FIG. 7B, in accordance with various embodiments. As previously discussed, the magnetic tab 146 may include a first magnet 148A and the lid body 115 may further include a second magnet 148B and a third magnet 148C. The second and third magnets 148B, 148C are positioned and designed to couple to the first magnet 148A such that when a respective pair of magnets 148A and 148B and/or 148A and 148C are coupled, the magnetic tab 146 may be held in at least an open and/or closed configuration. For example, when the first magnet 148A of the magnetic tab 146 couples with the second magnet 148B of the lid body 115, the magnetic tab 146 is held in a closed configuration preventing accidental spills of liquid from the travel assembly 100. In contrast, when the first magnet 148A of the magnetic tab 146 couples with the third magnet 148C of the lid body 115, the magnetic tab 146 is held in an open configuration ensuring the coverable opening 112 remains open and accessible for use. In some embodiments, the magnets 148 are positioned to assist with the opening and closing of the coverable opening 112. For example, when the magnetic tab 146 is in the closed position (e.g., the first magnet 148A is coupled to the second magnet 148B) and the magnetic tab 146 is pushed towards the third magnet 148C, the first magnet 148A may ‘jump’ from the second magnet 148B (e.g., decouple from the second magnet 148B) to the third magnet 148C (e.g., couple to the third magnet 148C) transitioning the magnetic tab 146 from the closed position to the open position. Similarly, when the magnetic tab 146 is in the open position (e.g., the first magnet 148A is coupled to the third magnet 148C) and the magnetic tab 146 is pushed towards the second magnet 148B, the first magnet 148A may ‘jump’ from the third magnet 148C (e.g., decouple from the third magnet 148C) to the second magnet 148B (e.g., couple to the second magnet 148B) transitioning the magnetic tab 146 from the open position to the closed position. In some embodiments, the magnetic tab 146 slides in a groove 116 of the lid body 115. In some embodiments, the magnetic tab 146 is not confined within the groove 116 and the magnets 148 are the only thing holding the magnetic tab 146 within the groove 116.

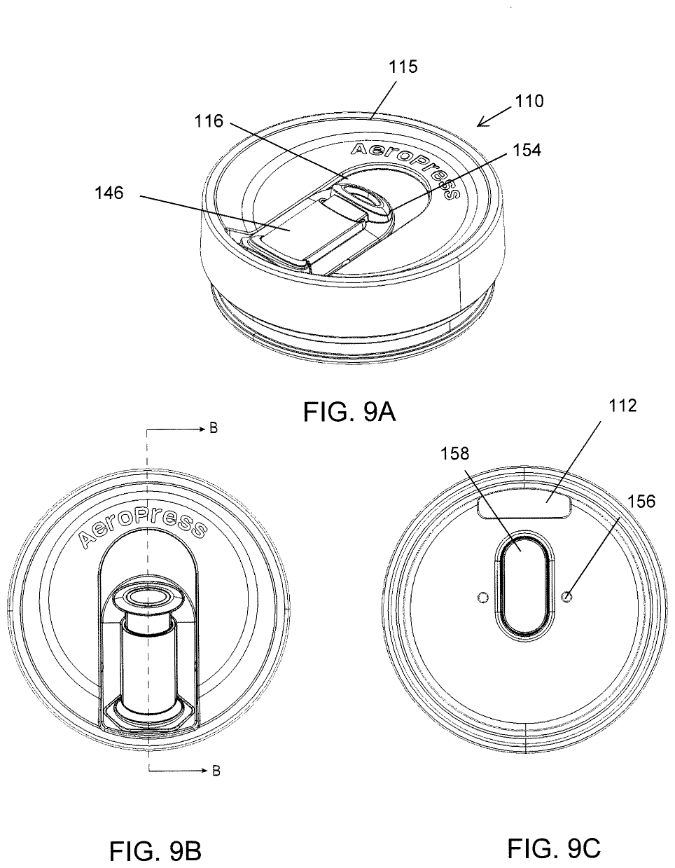

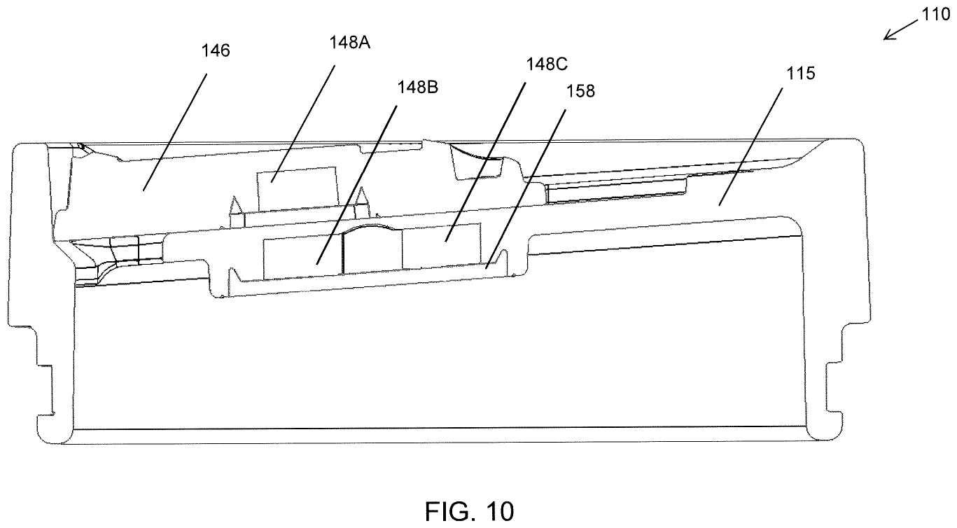

The configuration of the lid 110 may vary. FIGS. 9A-9C illustrate another exemplary lid 110 that includes a magnetic tab 146, and FIG. 10 illustrates a cross-sectional view of the exemplary lid 110 along plane B-B as shown in FIG. 9B, in accordance with various embodiments. As discussed with respect to FIGS. 7-8, the lid 110 includes a lid body 115 and a coverable opening 112 that a user can selectively open and close to facilitate use as a drinking container while traveling. In an embodiment, the coverable opening 112 may further comprise a magnetic tab 146 (e.g., a movable tab), which can be configured to transition between at least a closed position and an open position. For example, the magnetic tab 146 may configured to move to a closed position which corresponds to the coverable opening 112 being covered by the magnetic tab 146. Additionally or alternatively, the magnetic tab 146 may be configured to move to an open position corresponding to at least a portion of the coverable opening 112 being uncovered by the magnetic tab 146. As depicted in FIG. 10, the magnetic tab 146 may include one or more magnets 148 designed to couple with one or more magnets 148 in the lid body 115 such that the magnetic tab 146 may be held in at least an open and/or closed configuration.

FIG. 10 illustrates a cross-sectional view of the exemplary lid 110 along plane B-B as shown in FIG. 9B, in accordance with various embodiments. As previously discussed, the magnetic tab 146 may include a first magnet 148A such that the magnetic tab 146 is configured to transition between positions. The lid body 115 may further include a second magnet 148B and a third magnet 148C. The second and third magnets 148B, 148C are positioned and designed to couple to the first magnet 148A such that when a respective pair of magnets 148A and 148B and/or 148A and 148C are coupled, the magnetic tab 146 may be held in at least an open and/or closed configuration. For example, the first magnet 148A of the magnetic tab 146 may be configured to couple to the second magnet 148B of the lid body 115 such that the magnetic tab 146 is maintained in a closed position. In such a closed position, accidental spills of liquid from the travel assembly 100 can be avoided. In another example, the first magnet 148A of the magnetic tab 146 may be configured to couple to the third magnet 148C of the lid body 115 such that the magnetic tab 146 is maintained in an open position. In such an open position, the coverable opening 112 can be secured open and accessible for use.

In some embodiments, the magnets 148 are positioned to assist with the opening and closing of the coverable opening 112. For example, when the magnetic tab 146 is in the closed position (e.g., the first magnet 148A is coupled to the second magnet 148B) and a force is applied to the magnetic tab 146 in a first direction towards the third magnet 148C, the first magnet 148A may decouple from the second magnet 148B and subsequently couple to the third magnet 148C, transitioning the magnetic tab 146 from the closed position to the open position. Similarly, when the magnetic tab 146 is in the open position (e.g., the first magnet 148A is coupled to the third magnet 148C) and a force is applied to the magnetic tab 146 in a second direction towards the second magnet 148B, the first magnet 148A may decouple from the third magnet 148C and couple to the second magnet 148B transitioning the magnetic tab 146 from the open position to the closed position.

While FIGS. 8 and 10 illustrate a lid 110 including three magnets 148, any number combination of magnets 148 may be included in the lid 110 to facilitate the opening and/or closing of the coverable opening 112. For example, the magnetic tab 146 may include a first magnet 148A and the lid body 115 may include second, third, and fourth magnet 148B, 148C. In such a configuration, the magnets 148 may be configured such that the magnetic tab 146 may be maintained in both an open and closed configuration as well as an intermediary configuration. Alternatively, the magnetic tab 146 may include a first magnet 148A and the lid body 115 may include a second magnet 148B where the second magnet 148B extends the length of the coverable opening 112. In such a configuration, the first magnet 148A may remain coupled to the second magnet 148B as the magnetic tab 146 is pushed along the coverable opening 112. Then the first magnet 148A and the second magnet 148B may maintain the magnetic tab 146 in any location along the coverable opening 112.

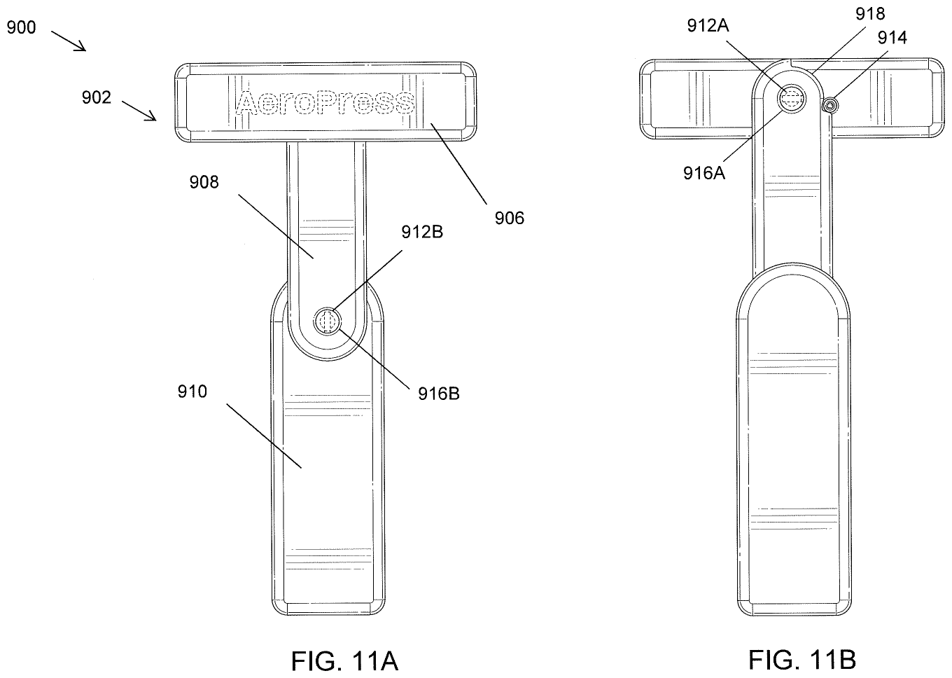

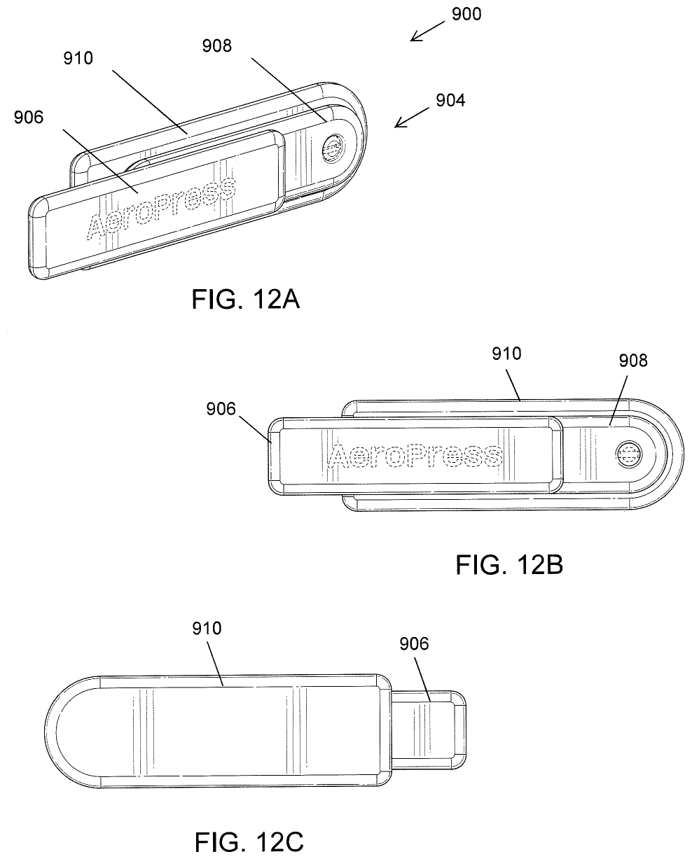

FIGS. 11A-11B illustrates an exemplary travel stirrer 900 in an expanded configuration 902, in accordance with various embodiments. The stirrer 900 may include a first portion 906, a second portion 908, and a third portion 910. The first portion 906 may attach to the second portion 908 and the second portion 908 may attach to the third portion 910 such that the stirrer 900 can transition between the expanded configuration 902 and a folded configuration 904, illustrated in FIGS. 12A-12C.

In this embodiment, the first portion 906 includes at least a first pivot 912A and a stop 914. The first pivot 912A may be configured to couple to a first hole 916A on a first end of the second portion 908 enabling rotation of the first portion 906 centered on the first pivot 912A by a predetermined degree of rotation. For example, the first portion 906 may rotate about the first pivot 912A in a first direction transitioning the stirrer from an expanded configuration to a folded configuration. In some embodiments, the first pivot 912A may be integrated into the first portion 906. In another embodiment, the first pivot 912A may be separatable from the first portion 906. For example, the first pivot 912A may be a screw attached to the first portion 906 and configured to couple to the first hole 916A of the second portion 908. The first pivot 912A may be any design suitable for enabling rotation of the first portion 906 about the first pivot 912A. For example, the first pivot 912A may be a pin attached to the first portion 906 and configured to couple to the first hole 916A of the second portion 908 enabling rotation. The first portion 906 may further include a stop 914. The stop 914 may be configured to limit the rotation of the first portion 906. For example, the stop 914 may limit the rotation of the first portion 906 about the first pivot 912A to 180 degrees. In an embodiment, the stop 914 may couple to a groove 918 of the second portion 908 to limit the rotation of the first portion 906 about the first pivot 912A. In this configuration, the length of the groove 918 may correspond to the degree of rotation limited by the stop 914 and groove 918. For example, as depicted in FIG. 11B, the length of the groove 918 may result in the rotation of the first portion 906 about the first pivot 912A being limited to 45 degrees. By limiting the rotation of the first portion 906 about the first pivot 912A, any logos and/or design on the face of the first portion 906 may be maintained in an upright position during use. For example, by limiting the rotation of the first portion 906 by 90 degrees, the logo can be positioned on the face of the first portion 906 such that it remains upright and legible to users when using the stirrer 900, as opposed to appearing upside down. In some embodiments, the stop 914 may be integrated into the first portion 906. In another embodiment, the stop 914 may be separable from the first portion 906. For example, the stop 914 may be a pin attached to the first portion 906. The stop 914 may be any design suitable for limiting rotation of the first portion 906 about the first pivot 912A.

In various embodiments, the second portion 908 may include at least the first hole 916A on the first end of the second portion 908 and a second hole 916B on a second end of the second portion 908. Both holes 916 may be designed to couple to pivots 912. For example, the first hole 916A may be configured to couple to the first pivot 912A and the second hole 916B may be configured to couple to the second pivot 912B.

In various embodiments, the third portion 910 may include at least the second pivot 912B. As discussed, the second pivot 912B may be configured to couple to the second hole 916B of the second portion 908. As a result, the third portion 910 may be enabled to rotate about the second pivot 912B by a predetermined degree of rotation. For example, the second hole 916B of the second portion 908 may be coupled to the second pivot 912B of the third portion 910 such that the third portion 910 may rotate by 360 degrees centered on the second pivot 912B. In another example, the third portion 910 may rotate about the second pivot 912B in a second direction transitioning the stirrer from a folded configuration to an expanded configuration. In some embodiments, the second pivot 912B may be integrated into the third portion 910. In another embodiment, the second pivot 912B may be separatable from the third portion 910. For example, the second pivot 912B may be a screw attached to the third portion 910 and configured to couple to the second hole 916B of the second portion 908. The second pivot 912B may be any design suitable for enabling rotation of the third portion 910 about the second pivot 912B. For example, the second pivot 912B may be a pin attached to the third portion 910 and configured to couple to the second hole 916B of the second portion 908 enabling rotation.

The stirrer 900 in the expanded configuration 902 may be characterized by a predetermined length and shape for ease of use and/or storage. In some embodiments, when the stirrer 900 is in the expanded configuration 902, the stirrer 900 may form a T-shape which may prevent the stirrer 900 from descending too far into the chamber of the beverage press 140 and/or the chamber of the tumbler 120. Specifically, when expanded 902, the first portion 906 may act as an upper stop (e.g., upper stop 410 illustrated in FIG. 4) and the length of the stirrer 900, measured from the second end of the third portion 910 (e.g., tip 411 illustrated in FIG. 4) to the first portion 906 (e.g., stop 410 illustrated in FIG. 4), may be slightly less than the length of the beverage press 140 and/or the tumbler 120. In turn, the first portion 906 acting as the upper stop may prevent the second end of the third portion 910 from touching the filter cap 144, the filter 131, bottom of the tumbler 120, etc. during stirring.

FIGS. 12A-12B illustrates the exemplary travel stirrer 900 in a folded configuration 904, in accordance with various embodiments. The stirrer 900 may be transitioned to a folded configuration 904 by aligning the first portion 906, the second portion 908, and the third portion 910 length wise. Specifically, the first portion 906 may be rotated about the first pivot 912A and the third portion 910 may be rotated about the second pivot 912B such that the first portion 906 and the third portion 910 are aligned with the second portion 908. By transitioning the stirrer 900 to the folded configuration 904, the footprint of the stirrer 900 can be reduced making the stirrer 900 easier to store and/or travel with. The footprint of the stirrer 900 in the folded configuration 904 may be sized such that the stirrer 900 may fit within the chamber of the beverage press 140 and/or inside the tumbler 120. Specifically, with respect to the beverage press travel assembly 100 depicted in FIGS. 1-3, the travel stirrer 900 may be stored within the tumbler 120 along with the beverage press 140. Thus, when the lid 110 and the bottom compartment 130 are secured to the tumbler 120 and the beverage press 140, the assembled travel kit (e.g., travel assembly 100) can securely hold all the components, including the travel stirrer 900 of the travel tumbler 120 and beverage press 140 needed to make and drink a coffee beverage while traveling.

While the above is a complete description of specific embodiments of the invention, the above description should not be taken as limiting the scope of the invention as defined by the claims. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. Any references cited herein are incorporated by reference herein in their entirety.

What is claimed is:

1. A portable assembly for making beverages, the portable assembly comprising:
a beverage filter press including:
a hollow cylinder having a first opening at a top side and a second opening at a bottom side;
a removable filter cap couplable to the hollow cylinder so as to enclose the second opening, and
a removable piston configured to be inserted into the hollow cylinder and create an airtight seal when coupled with the hollow cylinder;
a tumbler configured to receive the beverage filter press securely therein; and
a lid configured to securely attach to the tumbler for travel use and configured to securely attach to the bottom side to secure the beverage filter press within the portable assembly for portability.

2. The portable assembly of claim 1, wherein the lid is sized to accommodate a filter cap attached to the second opening of the hollow cylinder when secured to the hollow cylinder within the portable assembly.

3. The portable assembly of claim 1, wherein a support extends laterally outward from an exterior of the hollow cylinder at the bottom side, wherein the hollow cylinder comprises tabs extending from the support and configured to engage an inner surface of the lid to securely attach to the lid within the portable assembly.

4. The portable assembly of claim 3, wherein the tabs comprise at least a pair of tabs on opposite lateral sides of the hollow cylinder that engage the inside surface of the lid in a friction fit.

5. The portable assembly of claim 3, wherein the tabs comprise three or more tabs distributed about the second opening.

6. The portable assembly of claim 1, wherein the lid and the tumbler comprise corresponding threads to facilitate secure attachment of the lid to the tumbler for travel use.

7. The portable assembly of claim 1, wherein the tumbler includes an openable compartment at a bottom thereof for storing a stack of paper filters for use in the beverage filter press.

8. The portable assembly of claim 1, wherein the tumbler has a diameter at or near a bottom thereof sized at about 3.5 inches or less to fit within a standard cup-size holder.

9. The portable assembly of claim 1, wherein the portable assembly is provided to a user as a kit including a filter cap and a stack of paper filters stored within a bottom compartment of the tumbler.

10. The portable assembly of claim 1, wherein the hollow cylinder includes a silicone ring to secure the beverage filter press in place when disposed within the tumbler.

11. The portable assembly of claim 1, wherein at least the beverage filter press, the tumbler, and the lid are held together by a press-fit or friction-fit.

12. The portable assembly of claim 1, wherein the lid further comprises:
a movable tab including at least a first magnet and configured to transition between at least a closed position and an open position, wherein
the closed position corresponds to an opening being covered by the movable tab, and
the open position corresponds to at least a portion of the opening being uncovered by the movable tab; and
a body including at least a second magnet, a third magnet, and the opening, the body configured to securely attach to the tumbler for travel use, wherein
the first magnet of the movable tab is configured to couple to the second magnet such that the movable tab is maintained in the closed position, and
the first magnet of the movable tab is configured to couple to the third magnet such that the movable tab is maintained in the open position.

13. The portable assembly of claim 12, wherein the lid is configured such that when a force is applied to the movable tab in a first direction, the first magnet decouples from the second magnet and couples to the third magnet, transitioning the movable tab from the closed position to the open position, wherein the lid is configured such that when a force is applied to the movable tab in a second direction, the first magnet decouples from the third magnet and couples to the second magnet, transitioning the movable tab from the open position to the closed position, wherein the first direction and the second direction are opposite.

14. The portable assembly of claim 1, further comprising: a stirrer that is collapsible between an expanded configuration for stirring grounds within the hollow cylinder of the beverage filter press and a folded configuration that fits entirely within the hollow cylinder for storage.

15. The portable assembly of claim 14, wherein the stirrer further comprises:
a first portion comprising at least a first pivot and a stop,
a second portion comprising at least a first hole, a second hole, and a groove, wherein the first hole is rotatably coupled to the first pivot of the first portion to permit rotation of the first portion about the first pivot, wherein the groove is coupled to the stop of the first portion to limit the rotation of the first portion about the first pivot, and
a third portion comprising at least a second pivot, wherein, the second pivot is rotatably coupled to the second hole of the second portion to permit rotation of the third portion about the second pivot.

16. The portable assembly of claim 15, wherein the stirrer transitions to the expanded configuration by rotating the first portion about the first pivot in a first direction and rotating the third portion about the second pivot in the first direction.

17. The portable assembly of claim 16, wherein the stirrer transitions to the folded configuration by rotating the first portion about the first pivot in a second direction and rotating the third portion about the second pivot in the second direction, wherein the first direction and the second direction are opposite.

18. A lid comprising:
a movable tab including at least a first magnet and configured to transition between at least a closed position and an open position, wherein
the closed position corresponds to an opening being covered by the movable tab, and
the open position corresponds to at least a portion of the opening being uncovered by the movable tab; and
a body including at least a second magnet, a third magnet, and the opening, the body configured to securely attach to a tumbler for travel use, wherein
the first magnet of the movable tab is configured to couple to the second magnet such that the movable tab is maintained in the closed position, and
the first magnet of the movable tab is configured to couple to the third magnet such that the movable tab is maintained in the open position.

19. The lid of claim 18, wherein the lid is configured such that when a force is applied to the movable tab in a first direction, the first magnet decouples from the second magnet and couples to the third magnet, transitioning the movable tab from the closed position to the open position.

20. The lid of claim 19, wherein the lid is configured such that when a force is applied to the movable tab in a second direction, the first magnet decouples from the third magnet and couples to the second magnet, transitioning the movable tab from the open position to the closed position, wherein the first direction and the second direction are opposite.
